(19) United States
(12) Patent Application Publication
(10) Pub. No.: US 2024/0183551 A1
(43) Pub. Date: Jun. 6, 2024

(54) Blast Damper

(71) Applicant: Metropolitan Air Technology, LLC, Chicago, IL (US)

(72) Inventors: David Foss, Chicago, IL (US); Christopher Murphy, Chicago, IL (US)

(21) Appl. No.: 18/286,539

(22) PCT Filed: Apr. 14, 2022
(86) PCT No.: PCT/US2022/024850

§ 371 Date: Oct. 11, 2023

Related U.S. Application Data
(60) Provisional application No. 63/174,953, filed on Apr. 14, 2021.

(51) Int. Cl. F24F 11/32; F24F 13/15

(52) U.S. Cl. CPC F24F 11/32; F24F 13/15

(57) ABSTRACT

In one aspect, a remotely resettable blast damper for use with an air duct or wall opening is provided. The blast damper includes a blade configured to be mounted at a duct and movable between an open position and a closed position where the blade is configured to move to the closed position responsive to a blast wave. The blast damper includes a retention mechanism configured to maintain the blade in the closed position when the blade moves to the closed position. The blast damper further includes a release mechanism remote from the retention mechanism and operably coupled to the retention mechanism. Actuation of the release mechanism of the blast damper disengages the retention mechanism enabling the blade to return to the open position.

### CROSS-REFERENCE TO RELATED APPLICATIONS

This application claims benefit of U.S. Provisional Application No. 63/174,953, filed Apr. 14, 2021, which is hereby incorporated herein by reference in its entirety.

### FIELD

This disclosure relates to dampers for preventing high pressure blasts from entering a building or duct via a vent.

### BACKGROUND

Blast dampers are often used to prevent harmful blast pressure caused, for example, by an explosion, from entering and damaging buildings and ventilation systems. Often, blast dampers are placed at the intake or exhaust of a ventilation system of a building. When a blast or explosion occurs, the blast pressure causes blades of the blast damper to swing closed to inhibit the high-pressure wave caused by the blast from entering the ventilation duct and potentially causing damage to the building downstream, for example, to the ventilation duct. Blast dampers are constructed of strong, rigid materials that are able to withstand the high forces from a shockwave or blast without deformation, for example, the blades are made of a high gauge sheet metal. Other kinds of dampers, such as fire and smoke dampers, are made from lighter gauge material and are not able to withstand the high forces of a shockwave or blast. Moreover, the blades of fire and smoke dampers are often driven between open and closed positions by an electric motor/gear system (e.g., servo motor) to stop fire and/or smoke from moving through a building, for example, via an HVAC system. Such smoke and fire dampers are not able to protect against shockwaves or blasts because they are not able to react fast enough in response to a blast. Additionally, blast pressure would force the blades of the fire or smoke damper closed (or open) with such a high force and speed that would likely cause damage the electric motor/gear system, for example, strip or break the teeth of a gear.

One problem with existing blast dampers is that building owners desire the blast dampers to be resistant to corrosion. Some have galvanized the blast dampers so that the blast dampers are resistant to rusting. However, to provide the strength needed to withstand the shockwave of a blast, the blades of a blast damper are typically welded to a shaft the blades pivot about to the closed position to inhibit the blast pressure from passing through the blast damper. Welding galvanized steel is problematic in that the quality of welds is reduced and/or the corrosion resistance is reduced at the weld sites.

Other problems with existing welded blast dampers are that they are not modular, welded components cannot be easily replaced, and the blast damper cannot be easily modified or reinforced after installation. For example, if it is determined that the blades of a blast damper need further reinforcement after installation, the whole blast damper may need to be replaced or the welds removed which is often time consuming and costly. Similarly, if a blade or other sub-component of the blast damper has been damaged or if otherwise in need of repair, usually the entire damper would need to be replaced or re-welded. Blast dampers are often mounted at locations that are not easily accessible, which makes servicing such blast dampers all the more difficult.

Many blast dampers are configured such that the blades remain in the closed position after a blast occurs to provide protection from the subsequent negative phase of the blast or to protect against a second blast load (e.g., another explosion). To reset the blades to the open position requires access to the damper. Blast dampers are typically mounted in a duct of a ventilation system, or inside a wall opening, and access to the blast damper is often restricted. Therefore, it is typically not easy to manually reset the blades to the open position.

### SUMMARY

A blast damper is provided that is corrosion resistant, may be modified and reinforced during and after installation, and includes no welds while being able to withstand the shockwave of a blast. Additionally, the blast damper disclosed provides these benefits while reducing the cost of assembly and installation since the blast damper can be quickly and easily assembled without the additional costs associated with welding and skilled labor.

The blast damper disclosed includes a frame defining an opening and a blade assembly extending across the opening of the frame. The blade assembly includes a blade, an attachment bracket and a shaft. The attachment bracket includes a non-circular opening, such as a hexagonal opening, that receives the shaft. The shaft has a non-circular cross-sectional shape and extends through the non-circular opening of the attachment bracket. The cross-sectional shape of the shaft and the non-circular opening of the attachment bracket correspond such that the shaft is inhibited from substantial rotation within the non-circular opening of the attachment bracket, even when subjected to the shockwave of a blast. For example, the shaft has a hexagonal shape that is substantially the same as the hexagonal opening of the attachment bracket. The blade may be attached to the attachment bracket by fasteners and the shaft rotatably coupled to the frame such that the blade pivots with rotation of the shaft.

The shaft may further extend through non-circular openings of other components of the blast damper, such as a linkage arm and locking plates. As with the attachment bracket, the cross-sectional shape of the shaft may correspond to the non-circular openings of the linkage arm and locking plates such that the shaft is not able to rotate substantially within the non-circular openings, thus rigidly connecting the shaft thereto. Rotation of the shaft thus causes rotation of the blade, linkage arm, and locking plates.

Due to the interface of the shaft with the various components of the blast damper, the blast damper is able to withstand the shockwave of blasts, even without the use of welds to rigidly couple the shaft to the various components of the blast damper. The blast damper may be formed of a galvanized steel to provide resistance to corrosion. Since no welds are used, the blast damper is not prone to corroding as in prior dampers that have reduced resistance to corrosion at the weld sites.

Moreover, the blast damper may easily be modified to provide increased strength and meet blast load performance requirements during and after installation. The blast damper disclosed herein may easily be modified by removing or loosening fasteners, and adding or replacing one or more components of the blast damper.

In another aspect, the blast damper may be remotely resettable. The blast damper includes a blade or blades configured to be mounted at a duct and movable between an open position and a closed position where the blade is configured to move to the closed position in response to a blast wave. The blast damper includes a retention mechanism configured to maintain the blade(s) in the closed position when the blade(s) moves to the closed position. The blast damper further includes a release mechanism remote from the retention mechanism and operably coupled to the retention mechanism. Actuation of the release mechanism of the blast damper disengages the retention mechanism enabling the blade(s) to return to the open position. The release mechanism may be mounted at a location easily accessible so that the blast damper may be easily reset following a blast.

The retention mechanism of the blast damper may include a striker and a latch. One of the striker and the latch may be coupled to a blade of the blast damper with the blade connected to other blades of the blast damper via a mechanical linkage. The striker is arranged such that the striker contacts a portion of the latch as the blade moves into the closed position. The striker drives the latch from an unlocked configuration to a locked configuration that secures the striker within the latch and maintains the blade(s) in the closed position. Because the striker drives the latch to the locked configuration rather than a spring mechanism, for example, the striker is not able to bounce out of the latch before the latch is in the locked configuration. The retention mechanism may include a body to which the latch is mounted. The body of the retention mechanism may be positioned within the path of the striker and serve as a stop to prevent the striker from traveling beyond the body of the retention mechanism as the blade moves to the closed position.

### BRIEF DESCRIPTION OF THE DRAWINGS

FIG. 1 is a front perspective view of a blast damper of this disclosure.

FIG. 2 is a front perspective view of the blast damper of FIG. 1 shown with the blast plate removed.

FIG. 3 is a right rear perspective view of the blast damper of FIG. 1.

FIG. 4 is a right-side elevation view of the blast damper of FIG. 1.

FIG. 5 is a left-side elevation view of the blast damper of FIG. 1.

FIG. 6 is a top plan view of the blast damper of FIG. 1.

FIG. 7 is a top perspective view of a blade assembly of the blast damper of FIG. 1.

FIG. 8 is a bottom perspective view of the blade assembly of FIG. 7.

FIG. 9 is a right-side elevation view of the blade assembly of FIG. 7.

FIG. 10 is a top perspective view of the blade assembly of FIG. 7 shown with the blade removed.

FIG. 11 is a top perspective view of an attachment bracket of the blade assembly of FIG. 7.

FIG. 12 is a side perspective view of a linkage arm of the blade assembly of FIG. 7.

FIG. 13 is a top rear perspective view of a right-side portion of the blast damper of FIG. 1 shown with the blast plate and a locking plate removed.

FIG. 14 is a top front perspective view of a portion of the blast damper of FIG. 1 shown with the blast plate removed.

FIG. 15 is a top rear perspective view of a left-side portion of the blast damper of FIG. 1 shown with the blast plate removed.

FIGS. 16A-16B are front perspective and side elevation views, respectively, of a blast damper according to another embodiment shown with the blades in an open position.

FIG. 16C is a closeup view of a retention mechanism of the blast damper of FIG. 16A with a latch mechanism in an unlocked configuration.

FIGS. 17A-B are front perspective and side elevation views, respectively, of the blast damper of FIG. 16A shown with the blades in a closed position.

FIG. 17C is a closeup view of the retention mechanism of the blast damper of FIG. 16A with the latch mechanism in the locked configuration.

FIG. 18 is an exploded view of the latch mechanism of the blast damper of FIG. 16A.

FIG. 19 is a perspective view of a lock linkage according to another embodiment.

### DETAILED DESCRIPTION

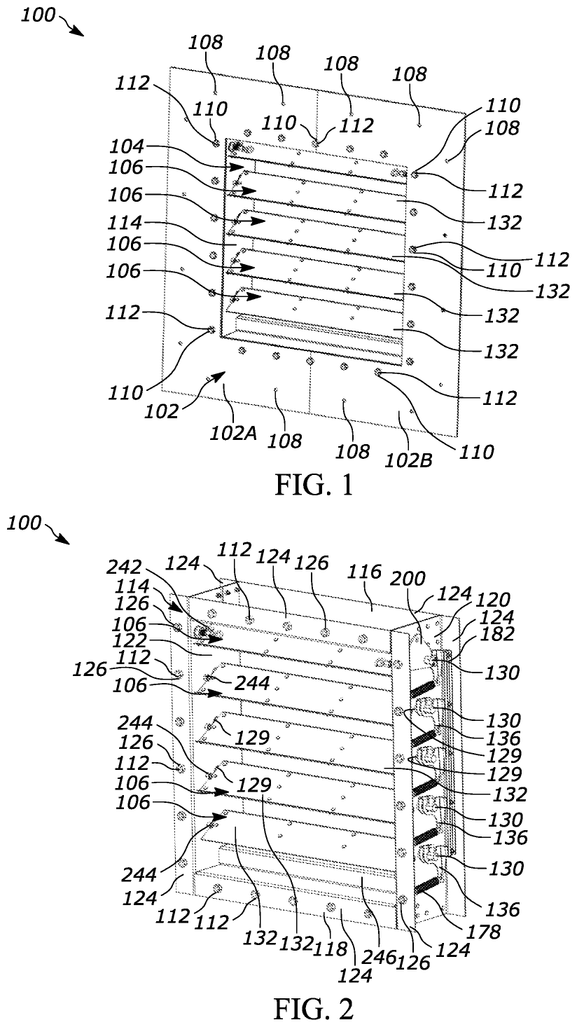

With respect to FIG. 1, a blast damper 100 is shown. The blast damper 100 includes a blast plate 102 positioned about an opening 104. The blast damper 100 includes a plurality of blade assemblies 106 having blades 132 positioned within the opening 104 that are configured to pivot between an open position permitting air to pass through the opening 104 and a closed position restricting the flow of air through the opening 104. As shown in FIG. 1, the blades 132 are in the open position. In the embodiment shown, the blade assemblies 106 are biased toward the open positions and are thus normally open. If a high-pressure wave of a blast approaches the blast damper 100 from the side having the blast plate 102, the high-pressure wave will apply a force to the blades 132 to rotate the blades 132 downward toward the closed position since the blades 132 are positioned at a slight angle in the open position. Once in the closed position, the flow of air through the blast damper 100 is restricted, thus aiding to inhibit the high-pressure blast and any subsequent negative pressure wave from causing damage downstream from the blast damper 100, for example, a ventilation duct to which the blast damper 100 may be connected.

The blast plate 102 includes a plurality of holes 108 for attaching the blast damper 100 to a building. For example, the blast damper 100 may be installed at the intake or exhaust of a ventilation system of a building. For instance, the blast damper 100 may be fastened to a wall having an opening that an end of a ventilation duct expels or intakes air through. The blast plate 100 may be fastened to the side of the wall that an anticipated blast is likely to come from such that the force of the blast forces the blast plate 102 against the wall. Due to the increased surface area of the blast plate 102, the blast plate 102 distributes the pressure from the blast over a larger surface area of the wall reducing the likelihood or degree of damage to the blast damper 100 or the wall during a blast. In the embodiment shown, the blast plate 102 is formed of a two halves 102A, 102B. In other forms, the blast plate 102 is a single plate. In some forms, the blast plate 102 may be formed of a metal such as steel or iron. In some forms, the blast plate 102 may coated with a corrosion resistant material. For example, where the blast plate 102 is formed of steel, the blast plate 102 may be galvanized or coated with zinc. In other forms, the blast plate 102 is formed of carbon steel or stainless steel.

The blast plate 102 further includes a plurality of holes 110 disposed about the inner opening 104 formed by the blast plate 102. These holes 110 receive fasteners 112 that attach the blast plate 102 to the frame 114 of the blast damper 100.

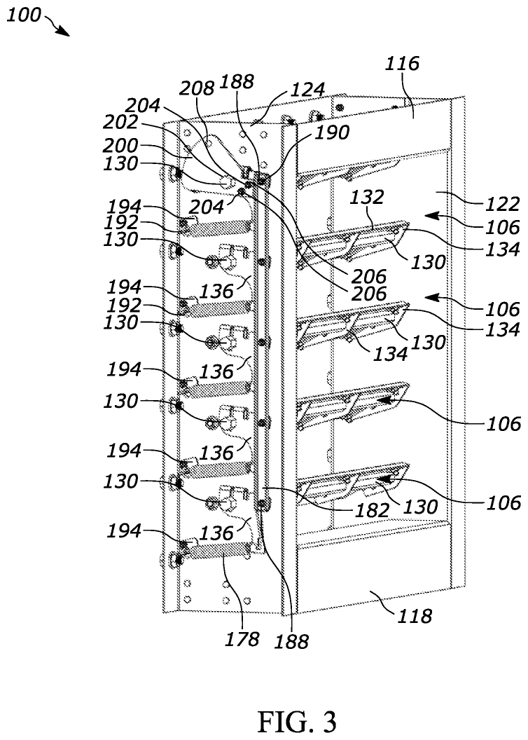

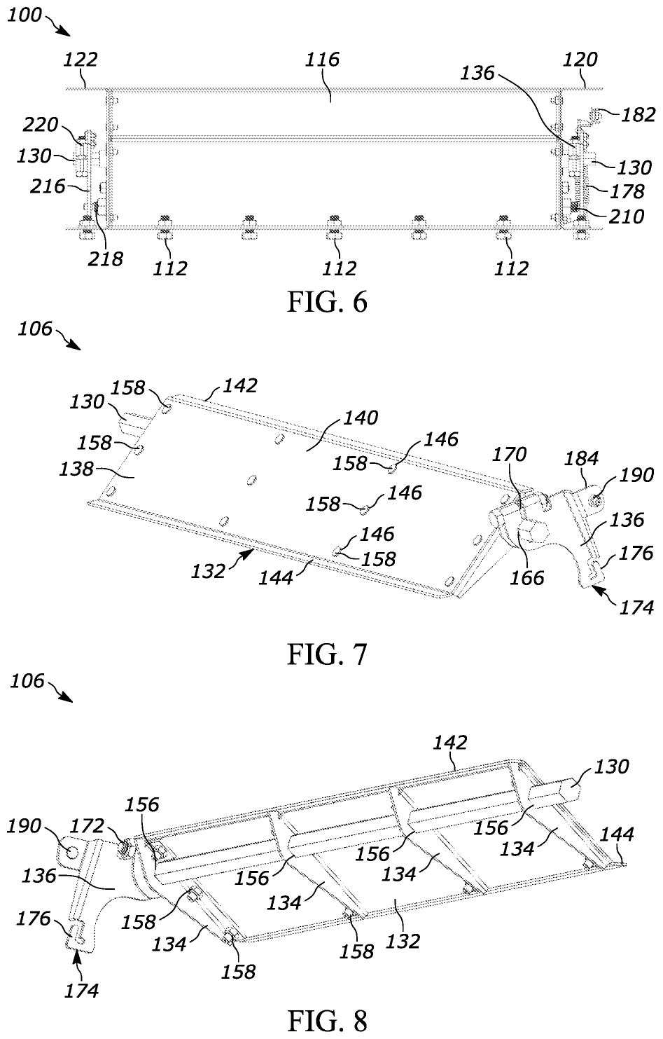

With respect to FIGS. 2-6, the blast damper of FIG. 1 is shown with the blast plate 102 removed. In the embodiment shown, the frame 114 of the blast damper 100 includes four members: a top member 116, a bottom member 118, and two side members 120, 122. In some forms, the frame 114 is formed of a metal such as steel (e.g., carbon steel or stainless steel) or iron. The frame 114 may coated with a corrosion resistant material, for example, the frame may be formed of a galvanized steel. Each of the members of the frame 114 include flanges 124 extending along either side of the member along the length thereof to provide increased strength to the frame 114. The frame 114 includes a plurality of holes 126 that align with the holes 110 of the blast plate 102. The fasteners 112 extend through the holes 110 of the blast plate 102 and the holes 126 of the frame 114 to attach the blast plate 102 to the frame 114. In the embodiment shown, the fasteners 112 include a bolt and a nut. In other forms, the blast plate 102 may be welded to the frame 114.

The side members 120, 122 form a series of holes 128 (see FIG. 5) along the length thereof for receiving a shaft 130 of the blade assemblies 106. The holes 128 are sized such that the ends of the shafts 130 extend through the corresponding holes 126 and are permitted to rotate. In the embodiment shown, a sleeve bearing 129 (see FIG. 2) may be positioned within each of the holes 128 that receive the shaft 130 and permit the shaft 130 to rotate within the holes 128. This permits the blade 132 that is coupled to the shaft 130 of the blade assembly 106 to pivot with the shaft 130 between open and closed positions. The sleeve bearing 129 may include a round outer surface configured to be positioned in and rotate within the hole 128 of the side members 120, 122. The sleeve bearing 129 may defines a non-circular through-hole for receiving the shaft 130. The non-circular through-hole may have a cross-sectional shape that corresponds to the cross-sectional shape of the shaft 130 that prevents the shaft 130 from rotating relative to the sleeve bearing 129. In other embodiments, a bushing may be positioned within the holes 128, with the shaft 130 extending through the bushing. The bushing allows the shaft to rotate within the holes 128 of the side members 120, 122. As described with respect the sleeve bearing 129, the bushing may define a through-hole having a non-circular cross-sectional shape that corresponds to the cross-sectional shape of the shaft 130 that prevents the shaft 130 from rotating relative to the bushing.

With reference to FIGS. 7-10, the blade assembly 106 includes the shaft 130, the blade 132, attachment brackets 134, and a linkage arm 136. The blade 132 may be formed of a plate 138 having a substantially planar central portion 140. The blades 132 may be configured to overlap when in the closed position to inhibit the flow of air through the interface between the upper and lower edges of the blades 132. The blades 132 may be formed of a metal such as steel or iron. In some forms, the blades 132 are corrosion resistant, for example, formed of a galvanized steel. In other forms, the blades 132 are formed of carbon steel or stainless steel.

In the embodiment shown, the plate 138 of the middle blades 132 includes an upper edge 142 bent out of alignment with the central portion 140 and lower edge 144 bent out of alignment with the central portion 140 and substantially parallel to the upper edge 142. When in the closed position, the upper edges 142 of the blades 132 abut the lower edges 144 of the adjacent blades 132. The uppermost blade 132 may not include such an angled upper edge 142 as the upper end of the uppermost blade 132 does not overlap with another blade. Likewise, the lowermost blade 132 may not include such a lower edge 144 as the lower end of the lowermost blade 132 does not overlap with another blade. Each blade 132 defines sets of attachment holes 146 for attaching the blade 132 to the attachment brackets 134. The attachment brackets 134 couple the blade 132 to the shaft 130.

With reference to FIG. 11, each attachment bracket 134 includes sets of attachment holes 148 that correspond and may be aligned with a set of attachment holes 146 of the blades 132. The attachment brackets 134 may be formed of a plate 150 that includes a blade attachment portion 152 and a shaft receiving portion 154. The blade attachment portion 152 may be at an angle relative to the shaft receiving portion 154, for example, a ninety-degree angle. Including a portion of the attachment bracket 134 (i.e., the shaft receiving portion 154) that extends perpendicular to the blade 132 provides increased strength and support to the blade 132 when subjected to forces, for example, increased pressure due to a blast.

The attachment bracket 134 may be formed of a metal plate that is stamped or laser cut and then bent to form the blade attachment portion 152 and shaft receiving portion 154. The attachment bracket 134 may be formed of steel (e.g., carbon steel) or iron. In some forms, the attachment brackets 134 are corrosion resistant, for example, formed of a galvanized steel or stainless steel. The blade attachment portion 152 defines the attachment holes 148 for coupling to the blade 132. The shaft receiving portion 154 defines a non-circular opening 156 for receiving the shaft 130 therein. The non-circular opening 156 may have the same shape as the cross-sectional shape of the shaft 130 and may be sized such that the shaft 130 is tightly received therein and not permitted to rotate substantially relative to the attachment bracket 134. As shown in FIG. 10, the shaft 130 extends through the non-circular openings 156 of each attachment bracket 134.

In the embodiment shown, the non-circular opening 156 has a hexagonal shape and the shaft 130 has a corresponding hexagonal cross-sectional shape. In other embodiments, the shape of the non-circular opening 156 and the cross-section of the shaft 130 may include any non-circular shape that inhibits the shaft 130 from rotating within the opening 156, for example, a substantially D-shape, triangular, square, octagonal, star-shaped, I-shaped, faceted surface, and the like. In the embodiment shown, the non-circular opening 156 is not fully enclosed and extends through the blade attachment portion 152. This enables a surface of the shaft 130 to directly engage the blade 132. This may provide an increased frictional force to prevent the shaft 130 from sliding substantially relative to the blade 132. In other embodiments, the non-circular opening 156 may be positioned further from the blade attachment portion 152 such that the non-circular opening 156 is enclosed on all sides. The shaft 130 may be formed of a metal such as steel (e.g., carbon steel) or iron. In some forms, the shaft 130 is corrosion resistant, for example, formed of a galvanized steel or stainless steel.

Fasteners 158 extend through each attachment hole 146 of the blade 132 and into an attachment hole 148 of the attachment bracket 134. In the embodiment shown, each attachment bracket 134 is attached to the blade 132 by three fasteners, however, in other embodiments other numbers of fasteners may be used. Also in the embodiment shown, the blade assembly 106 includes four attachment brackets 134 to couple the blade 132 to the shaft 130. In other embodiments, more attachment brackets 134 may be used to couple the blade 132 to the shaft 130. Using more attachment brackets 134 may increase the strength of the blade assemblies 106 and the blast damper 100 so that the blast damper 100 is able to withstand and protect a ventilation system from larger blasts. This also may enable the blast damper 100 to withstand larger blasts while sustaining less damage. Likewise, the number of attachment brackets 134 may be reduced in applications where a lower strength of the blade assemblies 106 and the blast damper 100 is sufficient. Using less attachment brackets 134 may reduce the cost of the blast damper and/or may decrease assembly time.

The attachment brackets 134 further may include a protrusion 160 that engages the upper edge 142 of the blade 132. The protrusion 160 provides increased strength to the upper edge 142 of the blade 132 so that the upper edge 142 does not bend or become damaged when the lower edge 144 of the adjacent blade swings into contact with the upper edge 142 in the closed position.

The blade assemblies 106 may be customizable and adjusted for each application by the installer/manufacturer. For example, the installer may form the attachment holes 146 in the blade 132 during assembly. For instance, the installer may determine or be instructed to use three attachment brackets 134 to couple the blade 132 to the shaft 130. The installer may, for example, drill three sets of attachment holes 146 to attach three attachment brackets 134 to the blade 132. Similarly, where more or less attachment brackets 134 are to be used, the installer could form the requisite number of sets of attachment holes 146 in the blade 132 to attach the desired number of attachment brackets 134. This also permits the blade assemblies 106 to be easily modified after installation, for example, if the strength of a blade assembly 106 is to be increased after installation. For instance, an installer may partially disassemble the blast damper 100, drill additional sets of attachment holes 146, and add additional attachment brackets 134 as desired. Such a customizable configuration permits easy modification during initial assembly and/or installation, as needed.

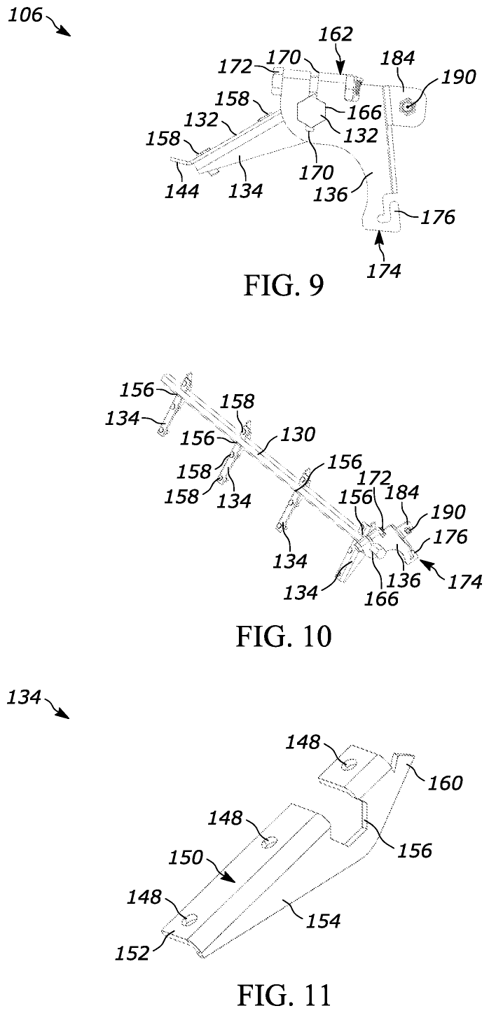

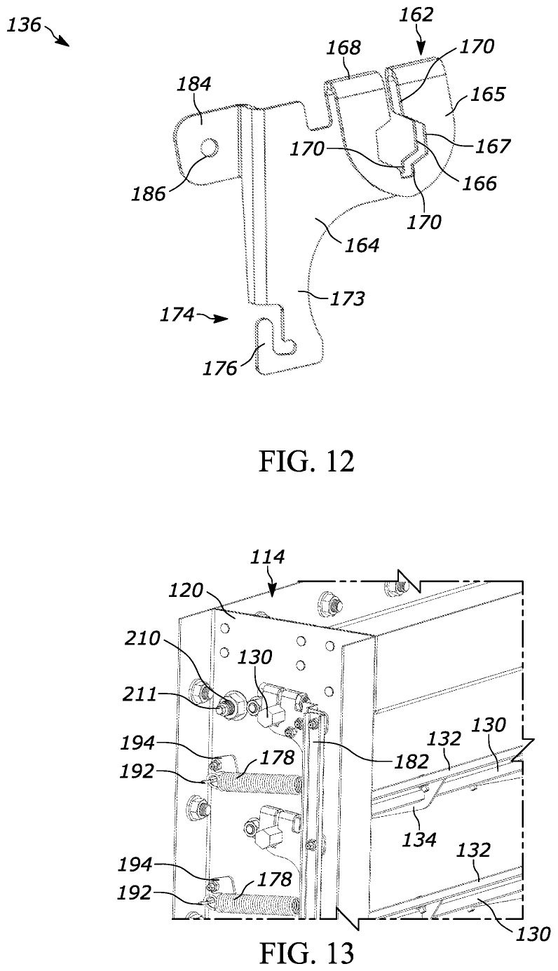

With reference again to FIGS. 7-10, the blade assemblies 106 each further include a linkage arm 136. The linkage arms 136 may be formed of a metal such as steel (e.g., carbon steel) or iron. In some forms, the linkage arms 136 are corrosion resistant, for example, formed of a galvanized steel or stainless steel. The linkage arm 136 is coupled to an end of the shaft 130 of a blade assembly 106 and is positioned on the outside of the side member 120 of the frame 114. As shown in FIG. 12, the linkage arm 136 includes a shaft attachment end 162 for attachment to the shaft 130. The shaft attachment end 162 is formed of two substantially parallel plates 164, 165 that each define a non-circular opening 166, 167 that corresponds to the cross-sectional shape of the shaft 130. This enables the end of the shaft 130 to be extended through the non-circular openings 166, 167 such that rotation of the shaft 130 causes the linkage arm 136 to rotate with the shaft 130. The parallel plates 164, 165 may be connected by a bend 168 such that the plates 164, 165 and the bend 168 form a U-shape. A slot 170 may extend across the non-circular opening 166 of the plate 164, over the U-shaped bend 168, and across the non-circular opening 167 of the plate 165. A fastener 172, such as a bolt and a nut, may be positioned between the two plates 164, 165 and within the U-shaped bend 168 (see FIG. 9). The fastener 172 may be tightened to apply a compressive force on the parallel plates 164, 165 and reduce the width of the slot 170. When the shaft 130 is positioned within the non-circular openings 166, 167 of the parallel plates 164, 165, tightening the fastener 172 causes the shaft attachment end 162 to clamp the shaft 130 to inhibit the shaft 130 from rotating within the non-circular openings 166, 167.

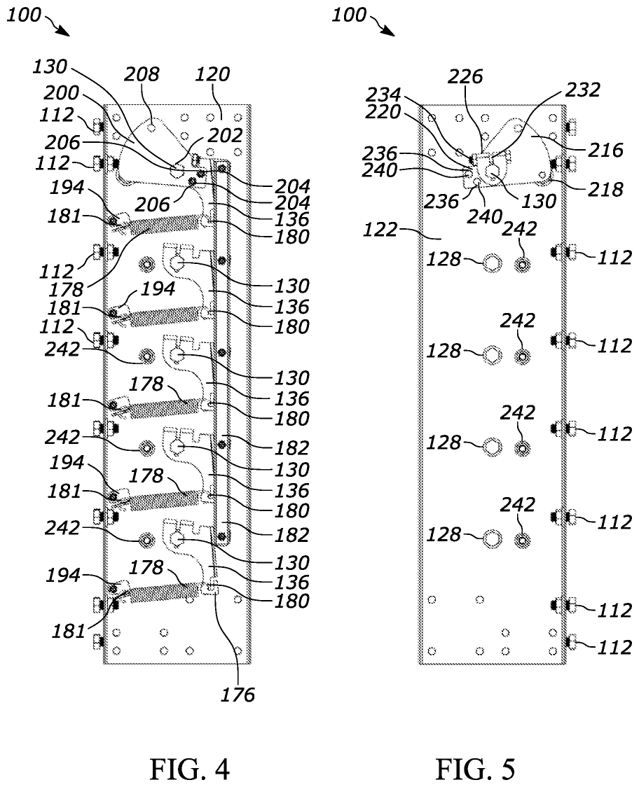

The linkage arm 136 includes an arm portion 173 that extends from the shaft attachment end 162 to the biasing member attachment end 174. When the shaft 130 rotates, the biasing member attachment end 174 pivots about the shaft 130. The biasing member attachment end 174 includes a hook 176 for attachment to a biasing member, such as spring 178 (see FIG. 4). Spring 178 may be formed of a coiled metal, such as steel, bronze, titanium, or combinations thereof. An attachment loop 180 of the spring 178 may be positioned over the hook 176 to connect the spring 178 to the biasing member attachment end 174. With reference to FIGS. 2-6, the opposite end of the spring 178 may include an attachment loop 181 that connects to a hook 192 of a bracket 194 mounted to the side member 120 of the frame 114. When the spring 178 is attached to both the bracket 194 and the biasing member attachment end 174, the spring 178 applies a force to the biasing member attachment end 174 pulling the biasing member attachment end 174 toward the bracket 194. This applies a torque to the shaft 130 via the shaft attachment end 162 that is coupled to the shaft 130 and the blade 132. The force of the spring 178 biases the blade 132 coupled to the shaft 130 to an open position. The blades 132 of the blast damper 100 are thus normally open. During a blast, the increased pressure applies a force to the blades 132 that overcomes the biasing force of the springs 178 causing the blades 132 to pivot toward the closed position. The biasing force of the springs 178 on the blades 132 is set or balanced so that the force applied to the blades 132 by a blast wave or high-pressure wave of a predetermined pressure differential causes the blades 132 to overcome the biasing force of the springs 178 and rotate to their closed position. The blast damper 100 may thus be set to close responsive to blast waves of a minimum pressure differential by adjusting the biasing force of the springs 178 on the blades 132. Because the blades 132 lock when in the closed position and are manually opened as described in further detail below, it is desired that the blades 132 close responsive to blast pressure and do not close responsive to lower pressure waves as this would result in a user having to manually reset the blast damper. This is especially problematic where the blast damper is positioned in a duct or other location that is not easily accessible.

The linkage arms 136 of each of the blade assemblies 106 of the blast damper 100 may be rigidly coupled to one another via a connecting rod 182. Each linkage arm 136 further includes a bent tab 184 defining a hole 186. The connecting rod 182 includes series of holes 188 for attachment to each of the linkage arms 136. A fastener 190 may be extended through the hole 186 of the linkage arm 136 and a corresponding hole 188 of the connecting rod 182. The fastener 190 may be, for example, a nut and bolt. When all of the linkage arms 136 are attached to the connecting rod 182, the blade assemblies 106 pivot about their respective shafts 130 synchronously. Stated differently, all of the blade assemblies 106 rotate together such that the blades 132 are all opened, are all closed, or are all at substantially the same angle between the open and closed positions. Thus, when a blast occurs, all of the blades 132 will be moved to the closed position together. This aids to ensure that a blade 132 will not remain in the open position when a blast occurs permitting the high pressure of the blast to pass through the blast damper without the full dampening of the blast damper 100, which could cause damage downstream. The connecting rod 182 may be formed of a metal such as steel (e.g., carbon steel) or iron. In some forms, the connecting rod 182 is corrosion resistant, for example, formed of a galvanized steel or stainless steel.

With reference again to FIGS. 2-6, the uppermost linkage arm 136 is coupled to a locking plate 200. The locking plate 200 defines a non-circular opening 202 for receiving the shaft 130. The non-circular opening 202 has a shape that corresponds to the cross-sectional shape of the shaft 130 and is sized such that the shaft 130 is not able to be rotated within the non-circular opening 202 when the shaft 130 is received therein. The locking plate 200 may further be coupled to the linkage arm 136 via fasteners 204 that extend through holes 206 of the locking plate 206 and corresponding holes of the linkage arm 136. The fasteners 204 may be, for example, a nut and a bolt. The locking plate 200 rotates as the shaft 130 is rotated, e.g., due to blast pressure forcing the blades 132 to a closed position.

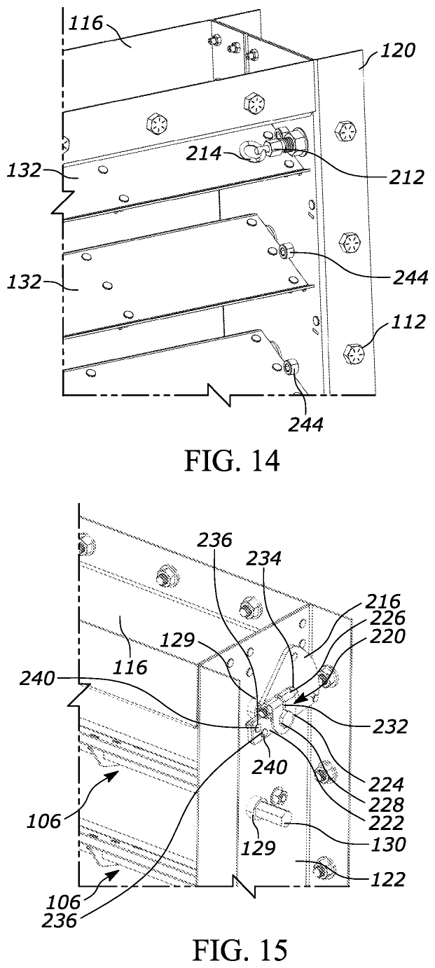

The locking plate 200 further defines a locking hole 208 that is configured to receive a locking pin 210. The locking hole 208 may be circular or a slot as some examples. With reference to FIGS. 13-14, the locking pin 210 is secured to the side member 120 of the frame 114. The locking pin 210 may include a threaded shaft and be secured to the side member 120 by nuts on either side of the side member 120. The locking pin 210 includes a spring that forces a plunger 211 of the locking pin 210 outward and into engagement with the locking plate 200. When the blades 132 are forced to a closed position, the locking plate 200 is rotated with the shaft 130 until the locking hole 208 is aligned with the locking pin 210. Due to the force of the spring on the plunger 211 of the locking pin 210 on the locking plate 200, an increased force may be required to move the blade 132 associated with the locking plate 200 to the closed position. By using a connecting rod 182 as described above, the force of the blast on all of the blades 132 may be used to force the blade assembly 106 with the locking plate 200 to the closed position. Once the locking pin 210 is aligned with the locking hole 208, the spring of the locking pin 210 forces the plunger 211 into the locking hole 208 of the locking plate 200. This locks the blades 132 in the closed position such that the blades 132 do not return to the open position after the initial high-pressure wave of a blast, for example, due to the negative pressure following a blast or the biasing force of the springs 178. Since the blades 132 are connected via the connecting rod 182, all of the blades 132 remain in the closed position when the plunger 211 of the locking pin 210 is in the locking hole 208 and inhibit any subsequent blast, high pressure wave, and/or negative pressure wave from damaging the building or ventilation duct downstream of the blast damper 100.

As shown, the locking pin 210 may include a head 212 that permits the locking pin 210 to be turned to adjust the position of the locking pin 210 relative to the locking plate 200. The locking pin 210 further includes a gripping ring 214 that may be used to move the plunger 211 between extended and retracted positions. For example, the gripping ring 214 may be pulled to overcome the force of the spring on the plunger 211 to withdraw the plunger 211 from the locking hole 208 of the locking plate 200. The gripping ring 214 may be released to allow the spring to force the plunger 211 to the extended position, for example, to force the plunger 211 against the locking plate 200. When the blades 132 have been moved to the closed position (e.g., by the force of a blast) and the plunger 211 of the locking pin 210 is within the locking hole 208 of the locking plate 200, the gripping ring 214 of the locking pin 210 may be used to reset the blast damper 100 by disengaging the locking pin 210 and allowing the plunger 211 to be withdrawn from the locking hole 208 to permit the blades 132 to return to the open position (e.g., by the biasing force of the springs 178). The gripping ring 214 may then be released to permit the spring to force the plunger 211 of the locking pin 210 into engagement with the locking plate 200. The blast damper 100 is then reset, with the blades 132 in the normally open position and ready to prevent the next blast.

In this embodiment, as shown in FIGS. 5, 6 and 15, the other side member 122 of the frame 114 may also include a locking plate 216 and a corresponding a locking pin 218 that functions similarly to the locking plate 200 and locking pin 210 of the side member 120. The locking plate 216 may include a non-circular opening for receiving the shaft 130 similar to the locking plate 200. The locking plate 216 may further be secured to the shaft 130 via a clamping mechanism 220 that is similar to the shaft attachment end 162 of the linkage arm 136. The clamping mechanism 220 includes two substantially parallel plates 222, 224 that are connected by a bend 226 to form a U-shape. Each of the plates 222, 224 includes a non-circular opening 228 that has a size and shape that corresponds to the cross-sectional shape of the shaft 130. A slot 232 may extend across the non-circular opening 228 of the plate 222, over the U-shaped bend 226, and across the non-circular opening 228 of the plate 224. A fastener 234, such as a bolt and a nut, may be positioned between the plates 222, 224 and within the U-shaped bend 226. The fastener 234 may be tightened to apply a compressive force on the ends of the parallel plates 222, 224 to reduce the width of the slot 232. When the shaft 130 is positioned within the non-circular openings 228 of the parallel plates 222, 224, tightening the fastener 234 causes the clamping mechanism 220 to clamp the shaft 130 to inhibit the shaft 130 from rotating within the non-circular openings 228.

In the embodiment shown, the plate 222 of the clamping mechanism 220 includes a protrusion defining attachment holes 236 to attach the clamping mechanism 220 to the locking plate 216. The locking plate 216 includes complementary attachment holes enabling fasteners 240, such as a bolt, to be extended through the attachment holes 236 of the clamping mechanism 220 and the attachment holes of the locking plate 216 to rigidly secure the locking mechanism 220 to the locking plate 216. This prevents the locking plate 216 from sliding along the shaft 130 and ensures that rotation of the shaft 130 causes the locking plate 216 to rotate due to the rigid connection with the clamping mechanism 220.

The side members 120, 122 define a series of holes 242 through which stoppers 244 are fastened. The stoppers 244 may be a fastener, such as a nut and a bolt, this is positioned to extend into the pathway of a blade 132 as it rotates. The stoppers 244 may be positioned to set how far open the blades 132 are permitted to open. As shown, the stoppers 244 are positioned such that the blades 132 are at a slight angle when in the fully open position and are not permitted to rotate to a position such that the central portion 140 of the blade 132 is parallel with the flow of air through the opening 104. This enables the blades 132 to be positioned at a slight angle such that a blast or a high-pressure wave approaching from the front side of the blast damper 100 with the blast plate 102 will cause the blades 132 to predictably swing downward to the closed position.

The bottom member 118 of the frame 114 includes a step 246 against which the lowermost blade 132 abuts when in the closed position. This step 246 provides a stop that sets the position of the blade 132 when in the closed position. The upper edge 142 of the lowermost blade abuts the lower edge 144 of the immediately above blade 132 and provides a stop against which the lower edge 144 abuts in the closed position. The upper edge 142 for the other blades similarly provide a stop for the immediately above blade 132 when in the closed position. In some forms, the top member 116 of the frame 114 includes a step or a stop against which the uppermost blade 132 abuts when in the closed position.

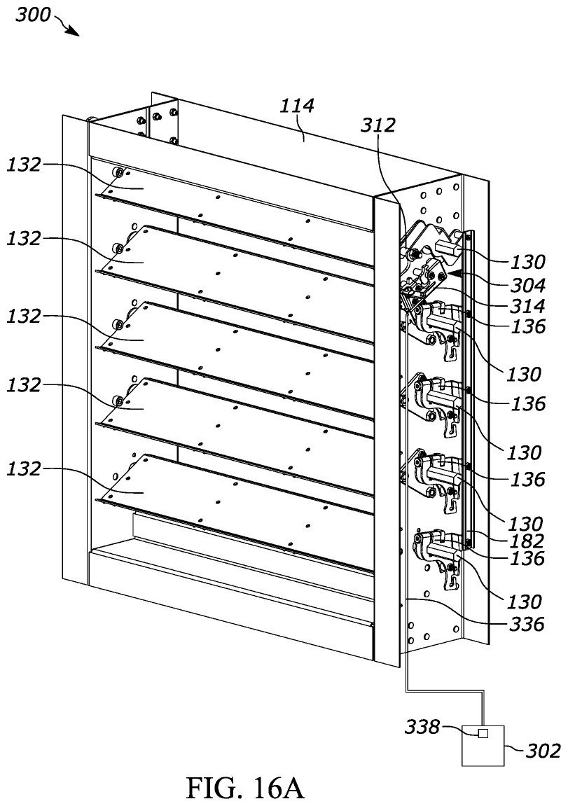

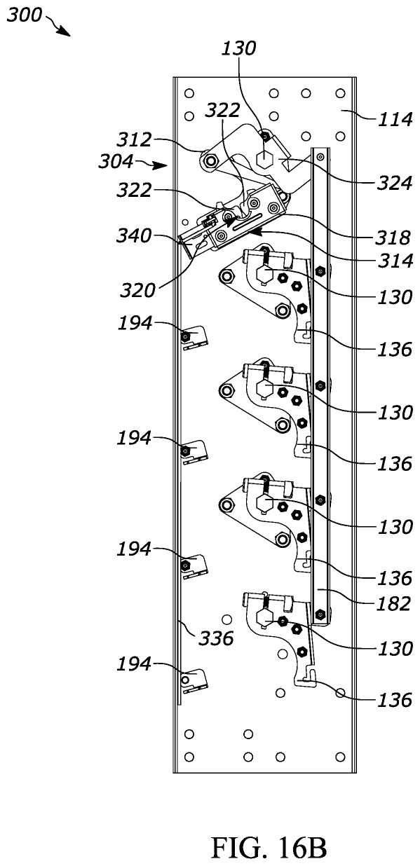

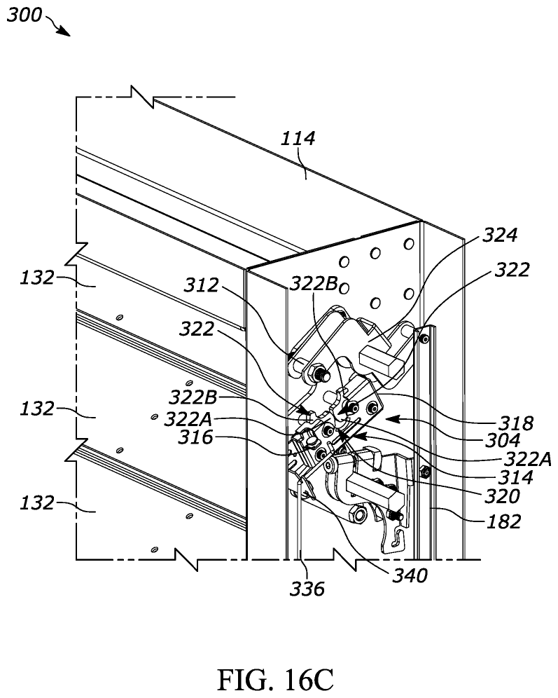

With respect to FIGS. 16A-18, a blast damper 300 is shown according to another embodiment that is similar in many respects to the blast damper 100 of FIGS. 1-15 described above such that the differences will be highlighted in the following discussion. For conciseness and clarity, similar features in the blast damper 300 are indicated with reference numerals used with respect to the blast damper 100 of FIGS. 1-15. A primary difference of the blast damper 300 is that the blast damper 300 includes a retention mechanism 304 that holds the blades 132 in a closed position along with a release mechanism 302 that is remote from the retention mechanism 304 that is actuatable to cause the retention mechanism 302 to release the blades 132 and allow the blades 132 to return to their open position. A user may thus actuate the release mechanism 302 from the remote location to reset the blades 132 to their open position. This is advantageous over blast damper systems where a servicer has to physically access the blast damper to reset the blast damper because blast dampers are often mounted in locations that are not easily accessible. For example, a servicer may need to use a ladder to access blast dampers installed at a vent twelve feet above the ground. As another example, a blast damper may be installed within a duct requiring a servicer to crawl within the duct to reset the blast damper.

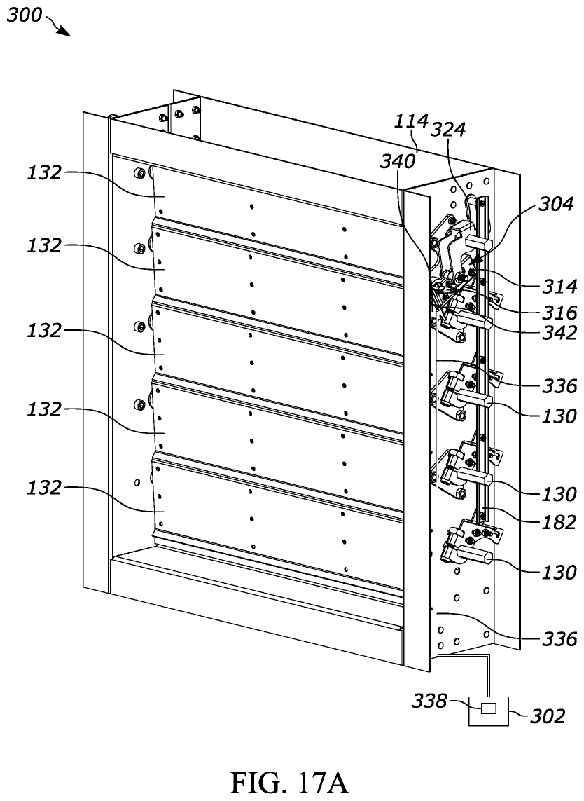

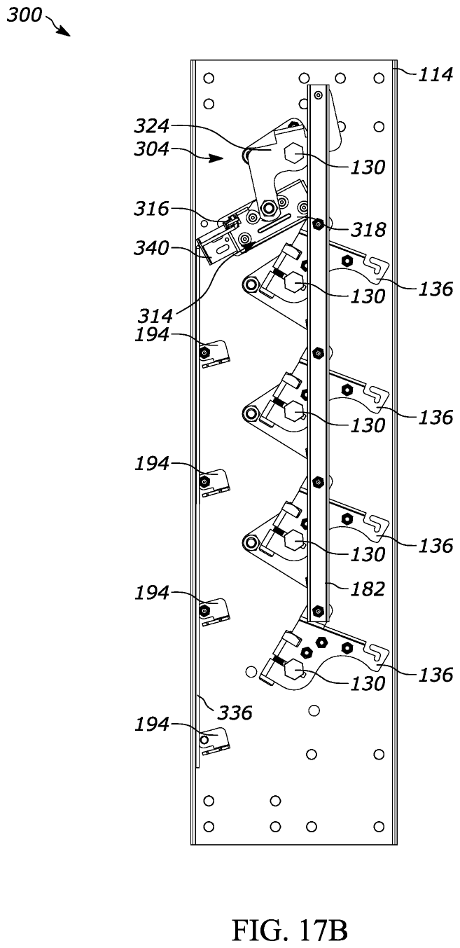

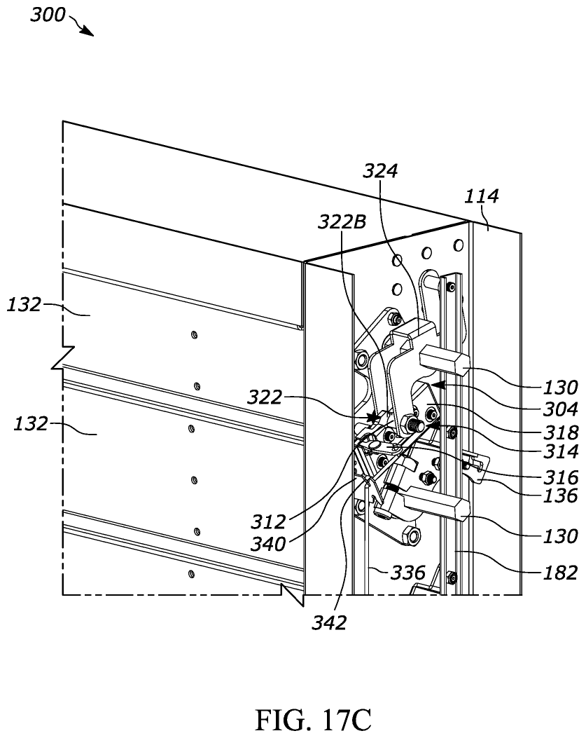

With respect to FIGS. 16A-17C, the blast damper 300 includes a frame 114 to which blade assemblies 106 (see FIGS. 7-10) including the blades 132 are mounted as described above. A connecting rod 182 is connected to the blade assemblies 106 so that the blades 132 move together between their open positions as shown in FIGS. 16A-16C and the closed positions as shown in FIG. 17A-17C. Biasing members, such as springs, may apply a biasing force to the blade assemblies 106 as described in the above embodiments to bias the blades 132 toward their open positions. The biasing members may apply a biasing force sufficient to prevent the blades 132 from moving to the closed position from pressures that do not exceed a minimum threshold pressure.

Responsive to a blast pressure that exceeds the minimum threshold, the force applied to the blades 132 overcomes the biasing force of the biasing members causing the blades to move to their closed position. When the blades 132 move to the closed position, the retention mechanism 304 retains the blades 132 in the closed position and inhibits the blades 132 from moving back to the open position. As discussed above, maintaining the blades 132 in the closed position inhibits subsequent blast pressure waves from traveling through the blast damper 300 and down the duct as well as inhibits a negative pressure wave following the blast pressure from causing damage. The retention mechanism 304 includes a striker 312, a latch mechanism 314, and a release lever 316. The latch mechanism 314 may include a body 318 with a notch or recessed portion 320 for receiving the striker 312 and latches 322 pivotably mounted within the body 318 for securing the striker 312 within the recessed portion 320 of the body 318. While two latches 322 are shown, a single latch 322 that closes off the mouth of the recessed portion 320 could similarly be used.

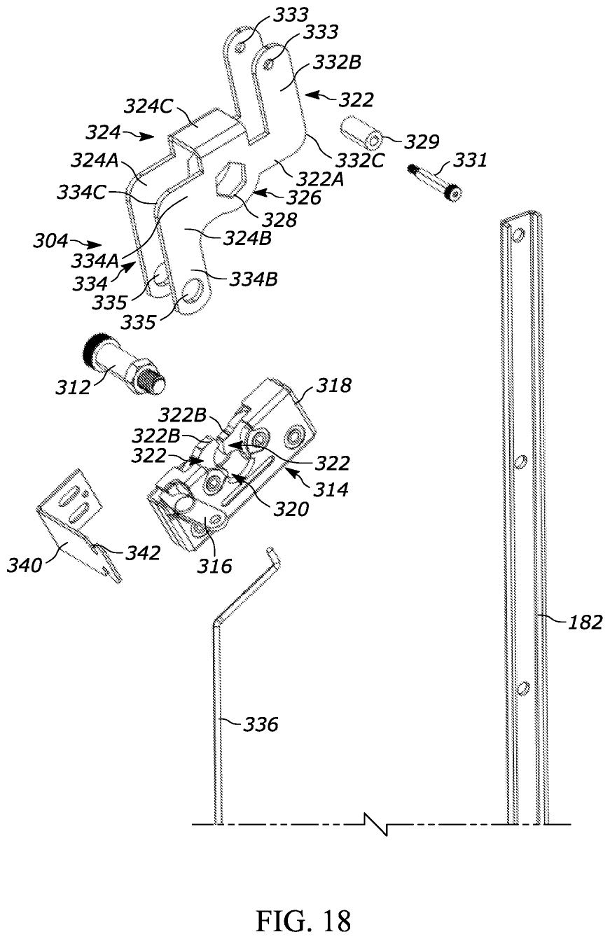

In the embodiment shown, the blast damper 300 includes a lock linkage 324. The lock linkage 324 includes a first plate 324A and a second plate 324B spaced apart from one another and extending substantially parallel to one another (see FIG. 18). Including two plates 324A, 324B may increase the rigidity of the lock linkage 324 and prevent the lock linkage 324 from bending, for example, when the striker 312 slams against the latch mechanism 314. The first plate 324A and second plate 324B include a connecting member 324C rigidly connecting the two plates 324A, 324B. The lock linkage 324 has a central portion 326 with an opening 328 for receiving a shaft 130 of the blade assembly 106 therethrough. The opening 328 may be a non-circular opening corresponding to the non-circular cross-section shape of the shaft 130 as in the above-described embodiments. For example, the shaft 130 and the opening 328 of the lock linkage 324 may be hexagonal. In other forms, the opening 328 is circular, the shaft 130 has a circular cross-sectional shape, and the lock linkage 324 has clamping mechanism (e.g., set screw, screw clamp, etc.) for rigidly securing the lock linkage 324 to the shaft 130.

The lock linkage 324 includes a first arm 332 and a second arm 334 extending from the central portion 326 of the lock linkage 324. The first arm 332 extends to the connecting rod 182. The first arm 332 includes a first portion 332A and a second portion 332B connected by a bend 332C. The second portion 332B may extend substantially perpendicular to the first portion 332A. The second portion 332B may include openings 333 through which a fastener 331 may be extended to secure the connecting rod 182 to the first arm 332. A spacer 329 may be positioned between the two plates 324A, 324B to space the plates 324A, 324B apart from one another as the fastener 331 is secured to the first arm 332. The first arm 332 thus connects the blade 132 to which the lock linkage 324 is attached (the uppermost blade in the form shown) to the other blades 132 of the blast damper 300 such that the blades 132 of the blast damper 300 open and close together as described above.

The second arm 334 extends from the central portion 326 and includes the striker 312 attached thereto. The striker 312 may include a rod that extends between the two plates 324A, 324 of the lock linkage 324. The second arm 334 may include openings 335 for attaching the striker 312 to the second arm 334. The second arm 334 includes a first portion 334A and a second portion 334B connected by a bend 334C. The second portion 334B may extend substantially perpendicular to the first portion 334A. The first portion 332A of the first arm 332 and the first portion 334A of the second arm 334 may extend substantially parallel to one another. The second portion 332B of the first arm 332 and the second portion 334B of the second arm 334 may extend substantially parallel to one another and extend in opposite directions from one another from the first portions 332A, 334A of the first and second arms 332, 334. This configuration of the locking arm 332 with the bends 332C and 334C may provide increased strength and rigidity to the lock linkage 324 to prevent the arms 332, 334 from bending substantially as the striker impacts the latch mechanism 314.

As the lock linkage 324 rotates (due to force applied via the connecting rod 182 to the first arm 332 and/or rotation of the shaft 130 from the movement of the blades), the striker 312 pivots about the shaft 130. As the blades 132 move toward the closed position, the striker 312 moves toward the latch mechanism 314 such that when the blades 132 move to the fully closed position the striker 312 enters the recessed portion 320 of the latch mechanism 314. With the body 318 of the latch mechanism 314 positioned within the path of the striker 312, the striker 312 is not able to travel past the latch mechanism 314. In the form shown, as the striker 312 enters the recessed portion 320 of the body 318, the striker 312 engages a striking portion 322A of the latches 322 causing the latches 322 to pivot to bring a latching portion 322B of the latch 322 into the path of the striker 312 (see FIGS. 16C and 18), inhibiting the striker 312 from exiting the latch mechanism 314. The striker 312 thus drives the latches 322 to a locking configuration where the latches 322 secure the striker 312 to the latch mechanism 314. The latches 322 may be configured to lock in their locking configuration and may be inhibited from pivoting to return to their unlocked configuration. With the latch portion 322B of the latches 322 in the path of the striker 312, the striker 312 is thus not able to move out of the latch mechanism 314 and thus the blades 132 (connected via the lock linkage 324, connecting rod 182, and linkage arms 136) are retained in the closed position and are not able to return to their open positions.

Such a retention mechanism 304 that is positioned within the path of the striker 312 and where the striker 312 drives the latches 322 to the locked configuration provides advantages over other latching systems. For instance, high blast pressure waves cause the blades 132 to snap closed very quickly. In systems where a spring-loaded pin or latch bolt is used, the blades 132 may move at a such a high speed that the pin or latch bolt travels past the hole into which the pin or latch bolt is to extend before the spring is able to force the pin or latch bolt into the hole to lock the blades 132. Additionally, the striker 312 driving the latches 322 into their locked configuration as the striker 312 travels into the recessed portion 320 of the body 318 aids to ensure that the striker 312 is not able to bounce out of the latch mechanism 314 before the latches 322 are in the locked configuration, because movement of the striker 312 into the latch mechanism 314 is what drives the latch mechanism 314 into the locked configuration.

The release lever 316 may be pivoted causing the latches 322 to move to their unlocked configuration where the latching portions 322B do not extend into the mouth of the recessed portion 320 of the latch mechanism 314. With the latches 322 in the unlocked configuration, the latching portions 322B are not in the path of the striker 312 and the striker 312 is able to move out of the latch mechanism 314. The biasing members connected to the blade assemblies 106 bias the blades 132 to their open position such that when the latch mechanism 314 is in the unlocked configuration, the striker 312 is withdrawn from the latch mechanism 314 as the blades 132 are moved toward the open position.

Linkage 336 may extend from the release lever 316 to the release mechanism 302 mounted remote from the retention mechanism 304. A supporting bracket 340 may be mounted to the latch mechanism 314 or blast damper 300 to support the linkage 336 in a position such that movement of the linkage 336 pivots the release lever 316 in a direction the release lever 316 is intended to pivot about. The supporting bracket 340 may include a notch 342 holding the linkage 336 at the proper position and permitting the linkage 336 to move or slide relative to the supporting bracket 340. In other forms, the supporting bracket 340 may include an opening through which the linkage 336 extends that the linkage 336 may slide within.

The release mechanism 302 may be mounted to a wall in a location easily accessible to a servicer, for example, in a utility closet or mechanical room of a building. For instance, a building may include a panel with one or more release mechanisms 302 connected via linkages 336 to one or more blast dampers 300 of the building. The release mechanism 302 may include an actuator 338 connected to the release lever 316 of the retention mechanism 302 via the linkage 336. The actuator 338 may be, as examples, a lever, button, or push-pull knob connected to the release lever 316 of the retention mechanism 302 via the linkage 336 such that movement of the actuator 338 moves (e.g., pulls) the release lever 316. The linkage 336 may include a cable, rod, or the like, mechanically connecting the release mechanism 302 and retention mechanism 304. Actuation of the actuator 338 of the release mechanism 302 may apply a force to the release lever 316 to cause the latch mechanism 314 to move to its unlocked configuration, thus allowing the blades 132 to return to their open positions.

In other forms, the release mechanism 302 includes a button remote from the retention mechanism 306. When the button is pressed, a signal may be communicated via a wired or wireless connection to a motor or solenoid mechanically connected to the release lever 316 to move the release lever 316 or otherwise cause the latch mechanism 314 to move to its unlocked configuration. In one form, the button is a virtual button of a graphical user interface of a user device (e.g., personal computer, tablet computer, smartphone, etc.) such as a virtual button on a website or smartphone application. When the button is pressed, the user device may communicate a signal via a wireless signal (e.g., Bluetooth, Wi-Fi) to operate the motor or solenoid to unlock the latch mechanism. The user device may communicate the signal via one or more networks such as the internet and/or cellular networks. The blast damper 300 may include a computing device (e.g., microcontroller) communicatively coupled to the motor, solenoid, and/or latch mechanism 314 that receives the wireless signals and causes the motor, solenoid, and/or latch mechanism to operate to unlock the latch mechanism 314.

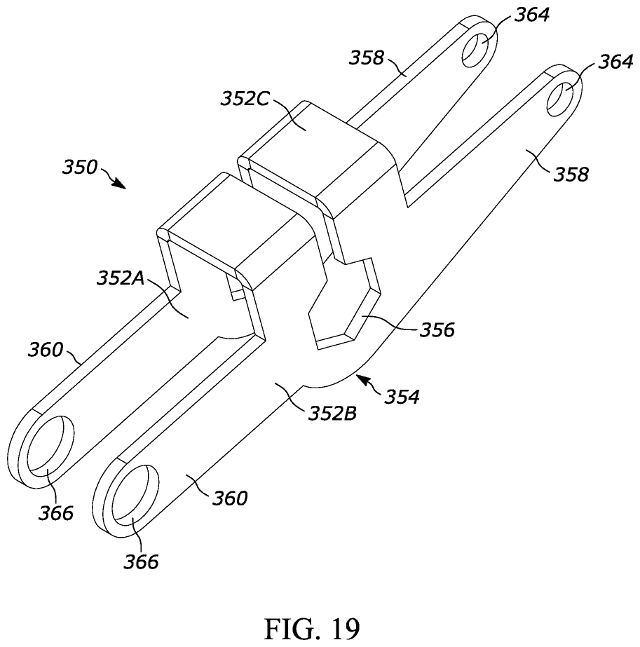

With respect to FIG. 19, a lock linkage 350 is shown according to an alternative embodiment. The lock linkage 350 may be used in place of the lock linkage 324 to connect the striker 312 to the connecting rod 182 so that when the striker 312 is locked in the latch mechanism 314 all the blades 132 are held in the closed position. The lock linkage 350 includes two plates 352A 352B spaced apart from one another and extending substantially parallel to one another. Including two plates 352A, 352B may increase the rigidity of the lock linkage 350 and prevent the lock linkage 350 from bending, for example, when the striker 312 slams against the latch mechanism 314. The first plate 352A and second plate 352B include a connecting member 352C rigidly connecting the two plates 352A, 352B. The lock linkage 350 has a central portion 354 similar to the lock linkage 324 described above with an opening 356 for receiving a shaft 130 of the blade assembly 106 therethrough. The opening 356 may be a circular or non-circular opening corresponding to the cross-section shape of the shaft 130 described above.

The lock linkage 350 includes a first arm 358 and a second arm 360 extending from the central portion 354 of the lock linkage 350. The first arm 358 extends to the connecting rod 182 and the second arm 360 holds the striker 312. The first arm 358 includes openings 364 for receiving the fastener 331 to secure the first arm 358 to the connecting rod 182. The second arm 360 includes openings 366 through which the striker 312 may be secured to the second arm 360. In contrast the lock linkage 324, the arms 358, 360 of the lock linkage 350 of FIG. 19 are substantially straight and do not include an angle or bend. The lock linkage 350 may be easier to manufacture than the lock linkage 324. The lock linkage 350 may be less prone to deformation under blast loads due to the straight configuration of the arms 358, 360. The lock linage 350 is also smaller in size than the lock linkage 324 which provides more space on the side of the blast damper 300 to include other mechanisms, if desired.

To use the blast damper 300, the blast damper 300 may be installed in a HVAC system. For example, the blast damper 300 may be installed at the vent of a duct of an HVAC system or within a duct of the HVAC system. The blast damper 300 may be placed in the HVAC system to prevent high pressure waves from passing beyond the blast damper 300 and causing damage to components of the ventilation system downstream of the blast damper 300, such as the duct, heating equipment, air-conditioning equipment, etc.

Responsive to a high-pressure wave, such as a blast caused by an explosion, the blades 132 of the blast damper 300 will move to their closed position and be locked in the closed position by the retention mechanism 304 as described above. With the blades 132 in the closed position, the HVAC system may be essentially inoperable as the blades 132 restrict the flow of air through the blast damper 300. To reset the blast damper 300 and permit the blades 132 to return to their open position, a release mechanism 302 of the blast damper 300 may be actuated to disengage the retention mechanism 304, for example, to cause the latch mechanism 314 to move to its unlocked configuration. As examples, actuating the release mechanism 302 may include moving a lever or pushing a button of the release mechanism 302. Actuating the release mechanism 302 may cause the linkage 336 (e.g., a cable) to apply a force to the release lever 316 of the retention mechanism 304, causing the latch mechanism 314 to move to the unlocked configuration. Once the retention mechanism 304 has been disengaged, the blades 132 may be drawn toward their open positions by the biasing mechanisms attached to the blades 132 that bias the blades 132 toward their open positions. As explained above, the release mechanism 302 may be remote from the retention mechanism 304 so that the release mechanism 302 may be actuated without having to be in physical proximity to or directly access the retention mechanism 304. The release mechanism 302 may be mounted at a location of the building that is easily accessible, thus allowing the blast damper 300 to be reset with little difficulty.

The following paragraphs are included to form a part of the content of this application, any of which may be considered to further define the concepts herein.

1. A method of using a blast damper having at least one blade movable between an open position and a closed position, the blast damper having a retention mechanism configured to retain the blast damper in the closed position when the blast damper moves to the closed position, the method comprising:
actuating a release mechanism of the blast damper when the at least one blade is in the closed position to disengage the retention mechanism from the at least one blade to enable the at least one blade to move toward the open position, at least a portion of the release mechanism remote from the retention mechanism of the blast damper.

2. The method of sub-paragraph 1 wherein actuating the release mechanism includes at least one of moving a lever or pushing a button of the release mechanism.

3. The method of sub-paragraph 1 wherein the release mechanism includes a cable extending to the retention mechanism, wherein actuating the release mechanism causes the cable to move a portion of the retention mechanism.

4. The method of sub-paragraph 1 further comprising installing the blast damper at a duct.

5. The method of sub-paragraph 1 wherein the at least a portion of the release mechanism remote from the retention mechanism is mounted at an accessible location.

6. A method of assembling a blast damper, the method comprising:
extending a shaft having a non-circular cross-sectional shape through a non-circular opening of one or more attachment brackets, the non-circular cross-sectional shape of the shaft corresponding to the non-circular opening of the one or more attachment brackets such that the shaft is not able to rotate substantially relative to the one or more attachment brackets;
removably attaching the one or more attachment brackets to a blade such that the blade is rigidly coupled to the shaft; and
rotatably coupling the ends of the shaft to a frame defining an opening, the blade being positioned within the opening.

7. The method of sub-paragraph 6 wherein the blade is rigidly coupled to the shaft without any welds.

8. The method of sub-paragraph 6 further comprising:
extending the shaft through a non-circular opening of a linkage arm such that the shaft is inhibited from substantial rotation within the non-circular opening of the linkage arm; and
securing an end of the linkage arm to a bracket of the frame via a biasing member such that the linkage arm biases the blade toward a position via the shaft.

Uses of singular terms such as “a,” “an,” are intended to cover both the singular and the plural, unless otherwise indicated herein or clearly contradicted by context. The terms “comprising,” “having,” “including,” and “containing” are to be construed as open-ended terms. It is intended that the phrase “at least one of” as used herein be interpreted in the disjunctive sense. For example, the phrase “at least one of A and B” is intended to encompass A, B, or both A and B.

While there have been illustrated and described particular embodiments of the present invention, those skilled in the art will recognize that a wide variety of modifications, alterations, and combinations can be made with respect to the above described embodiments without departing from the scope of the invention, and that such modifications, alterations, and combinations are to be viewed as being within the ambit of the inventive concept.

1. A remotely resettable blast damper comprising:
at least one blade configured to be mounted at a duct and movable between an open position and a closed position, the at least one blade configured to move to the closed position responsive to a blast wave;
a retention mechanism configured to maintain the at least one blade in the closed position when the at least one blade moves to the closed position; and
a release mechanism remote from the retention mechanism and operably coupled to the retention mechanism, wherein actuation of the release mechanism disengages the retention mechanism enabling the at least one blade to return to the open position.

2. The blast damper of claim 1 further comprising a biasing member coupled to the at least one blade and biasing the at least one blade toward the open position.

3. The blast damper of claim 1 wherein the retention mechanism includes a latch and a striker coupled to the at least one blade, the latch engaging the striker when the at least one blade is in the closed position and inhibiting the at least one blade from returning to the open position, wherein when at least one blade moves to the closed position the striker is brought into contact with the latch and drives the latch to the locked configuration and actuation of the release mechanism disengages the latch.

4. (canceled)

5. (canceled)

6. The blast damper of claim 1 wherein the retention mechanism includes a latch bolt and a strike plate, one of the latch bolt and the strike plate coupled to the at least one blade.

7. The blast damper of claim 1 wherein the release mechanism includes a lever and linkage, the linkage including a cable and/or a rod and being coupled to the lever and a release lever of the latch.

8.-12. (canceled)

13. The blast damper of claim 1 where the at least one blade is mounted to a frame configured to be placed within the duct and/or at an end of the duct.

14. A blast damper comprising:
at least one blade pivotably configured to be mounted at a duct and movable between an open position and a closed position;
a retention mechanism including a striker and a latch, one of the striker and the latch coupled to the at least one blade, wherein the striker contacts a portion of the latch as the at least one blade moves into the closed position driving the latch from an unlocked configuration to a locked configuration securing the striker within the latch and maintaining the at least one blade in the closed position.

15. The blast damper of claim 14 wherein the retention mechanism includes a body to which the latch is mounted, the body having a recessed portion for receiving the striker, wherein the latch and the body inhibit the striker from exiting the recessed portion when the latch is in the locked configuration.

16. The blast damper of claim 15 wherein the body of the retention mechanism is a stop preventing the striker from traveling beyond the body of the retention mechanism as the at least one blade moves to the closed position.

17. The blast damper of claim 14 wherein as at least one blade moves to the closed position the striker is brought into contact with the latch and drives the latch to the locked configuration and the latch engages the striker when the at least one blade is in the closed position inhibiting the at least one blade from returning to the open position.

18. (canceled)

19. The blast damper of claim 14 wherein the retention mechanism has a release lever actuatable to change the configuration of the latch from the locked configuration to the unlocked configuration and wherein actuation of a release mechanism remote from the retention mechanism moves the release lever to change the latch to the unlocked configuration.

20. (canceled)

21. The blast damper of claim 14 wherein the striker is coupled to the at least one blade.

22. A blast damper comprising:
a frame defining an opening;
a blade assembly coupled to the frame and extending across the opening of the frame, the blade assembly comprising:
a blade;
an attachment bracket secured to the blade and defining a non-circular opening; and
a shaft having a non-circular cross-sectional shape extending through the non-circular opening of the attachment bracket such that the shaft is inhibited from substantial rotation within the non-circular opening of the attachment bracket, the shaft rotatably coupled to the frame such that the blade pivots with rotation of the shaft.

23. The blast damper of claim 22 wherein the blade assembly further includes a linkage arm having a first non-circular opening through which the shaft extends such that the shaft is inhibited from substantial rotation within the non-circular opening of the linkage arm, the linkage arm biasing the blade toward a position via the shaft.

24. The blast damper of claim 23 wherein the linkage arm includes a biasing member attachment end for attachment to a biasing member, the biasing member applying a force to the biasing member attachment end to apply a torque to the shaft via the linkage arm.

25. The blast damper of claim 23 wherein the linkage arm includes a first plate portion defining the first non-circular opening and a second plate portion defining a second non-circular opening, the shaft extending through the first and second non-circular openings.

26. The blast damper of claim 25 further comprising a fastener and wherein the first plate portion and the second plate portion are connected via a bend portion and a slot extends from the first non-circular opening over the bend portion to the second non-circular opening, the fastener positioned to extend between the first plate portion and the second plate portion and to apply a force to the first and second plate portions to clamp the shaft within the first and second non-circular openings.

27. The blast damper of claim 22 wherein the blade assembly includes no welds.

28. (canceled)

29. The blast damper of claim 22 wherein the blade assembly further comprises a locking plate coupled to the shaft, the locking plate locking the blade in a closed position when the blade rotates to a closed position.

30. The blast damper of claim 22 wherein the frame defines an opening through which the shaft extends, a sleeve bearing being positioned within the hole between the shaft and the hole of the frame permitting the shaft to rotate within the hole.

31. The blast damper of claim 22 wherein the blade is pivotally mounted to the frame such that the blade is able to pivot relative the frame between an open position and a closed position.

32. The blast damper of claim 22 wherein the blade assembly includes a plurality of attachment brackets secured to the blade, each defining a non-circular opening through which the shaft extends such that the shaft is inhibited from substantial rotation within the non-circular openings of the attachment brackets.

33. The blast damper of claim 22 further comprising a plurality of blade assemblies coupled to the frame and extending across the opening of the frame, wherein each of the plurality of blade assemblies is adapted to pivot relative to the frame between an open position and a closed position, wherein when the plurality of blade assemblies are in the closed position, the opening defined by the frame is substantially covered by the plurality of blades.

34. (canceled)
